(19) United States
(12) Patent Application Publication
(10) Pub. No.: US 2010/0192096 A1
(43) Pub. Date: Jul. 29, 2010

(54) Biometrics based menu privileges

(75) Inventor: Edward A. Barrett, Itasca, IL (US)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Sony Electronics Inc., Park Ridge, NJ (US)

(21) Appl. No.: 12/320,462

(22) Filed: Jan. 27, 2009

(51) Int. Cl. G06F 3/048

(52) U.S. Cl. 715/811

(57) ABSTRACT

Automatically displaying differing menu listings from which selection of content is made based upon biometric identification. This may entail obtaining biometric information of a user from a selection device that is associated with a content access device through which access to content items is made. Once the user is identified by the biometric information, a modified menu list from which selection of content items is displayed, with the shown content items being tailored to the identified user. Selection of content items for reproduction by the content access device is then made. Different first and second biometric identification information may be used for a particular user to initially authenticate and identify the user, and then provide navigation among content menu lists according to the second biometric information.

### BACKGROUND OF THE INVENTION

1. Field of the Invention

This invention relates generally to selecting content and more particularly to automatically updating menu lists of available content through biometric identification.

2. Description of the Related Art

Home entertainment has and continues to rapidly evolve, with ever increasing content becoming seemingly available. For example, cable or satellite broadcasting system viewers may now expect to select programming from among hundreds of available channels. Also, the convergence of computer network architectures and traditional broadcast entertainment promises to further increase the availability of information. In addition to traditional program content, users may now store previously broadcast programs, personal content items including video, audio and still photos, and other content.

Typically, a user may preview available channels in sequential fashion, or may manually jump to a given channel, with each previewed channel occupying the entirety of the display. Various electronic program guides (EPGs), such as those provided in a cable television system or satellite system, have also become available to preview channels. Specifically, EPGs typically provide textual programming information about available channels. Many EPGs display a menu list in the form of a grid detailing certain programming information for the channels available for viewing. The columns in the grid may represent various programming times, while the rows in the grid may represent various available channels. The intersection of rows representing the available channels with the column for a given time provides the programming information for that time.

While conventional EPGs have been helpful in compiling channel information, they may be inadequate interfaces for users navigating among the varied and numerous content items that have become available.

Additionally, conventional menu listings (EPG and otherwise) do not efficiently convey information to particular users. One reason for this is that many users use but a small subset of the content that is actually available to them.

### SUMMARY OF THE INVENTION

The present invention provides biometric based menu privileges. This allows improved navigation among available content items by tailoring menu lists according to biometric identification. It also allows improved control of content by a parent, administrator, or other party having designated authority over the content to be accessed by others.

In one aspect, this entails automatically displaying differing menu listings from which selection of content is made based upon biometric identification. This may entail obtaining biometric information of a user from a selection device that is associated with a content access device through which access to content items is made. Once the user is identified by the biometric information, a modified menu list from which selection of content items is displayed, with the shown content items being tailored to the identified user. Selection of content items for reproduction by the content access device is then made. Different first and second biometric identification information may be used for a particular user to initially authenticate and identify the user, and then provide navigation among content menu lists according to the second biometric information.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a block diagram illustrating a content recording and reproducing device configured to include menu selection based upon biometric identification.

FIG. 2 is a block diagram further illustrating a content recording and reproducing device configured to include menu selection based upon biometric identification.

FIG. 3 is a flow diagram illustrating an example of automatically modifying menu lists of content items based upon biometric identification.

FIG. 4 is a flow diagram illustrating an example of automatically further modifying menu lists of content items based upon first and second different biometric identifications.

FIG. 5 is a schematic diagram illustrating an example of a system for navigating among content from various sources with biometric based menu list generation.

FIGS. 6A-B are display diagrams that respectively illustrate examples of a modified menu list and a further modified menu list.

FIG. 7 is a display diagram illustrating another example of a modified menu list with restricted content item access.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

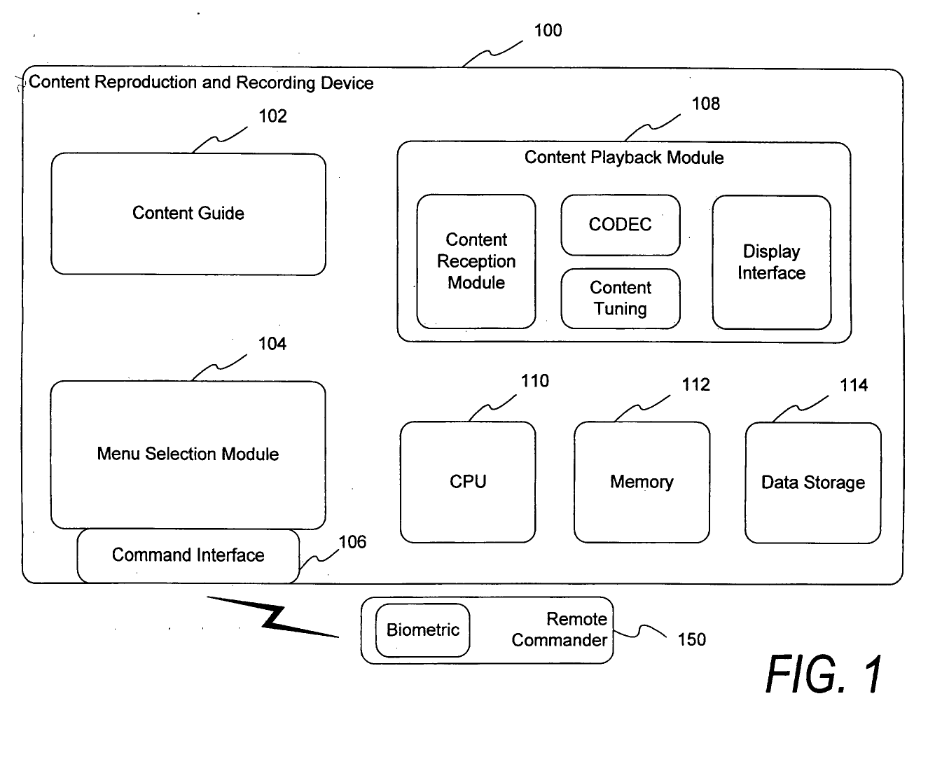

FIG. 1 is a block diagram illustrating a content recording and reproducing device 100 configured to include menu selection based upon biometric identification. The content recording and reproducing device 100 may be variously embodied, and in one example may provide a DVR functionality wherein the device is connected to a source of programming content, and functions to reproduce content for enjoyment, record content for storage and time shifting purposes, and also record personal content, with long term storage being provided via a data storage 114 such as a hard disk.

The device 100 is also configured to include a menu selection module 104 configured to implement one or more aspects of the invention. In the embodiment of FIG. 1, the device 100 includes a content processing module 108 that further includes a content reception module, a codec, a content tuning module, and a display interface. The content reception module is an input module that may accept video input streams in various forms (e.g., National Television Standards Committee (NTSC), PAL, Digital Satellite System (DSS), Digital Broadcast System (DBS), Advanced Television Standards Committee (ATSC), etc.). The streamed content may be based on Moving Pictures Experts Group (MPEG) standards for formatting the digital data stream that can be de-multiplexed and decoded to provide signals appropriate for outputting to any conventional display device. The demultiplexing and decoding functions may be provided by the noted CODEC and content tuning modules.

The content processing module 108 may thus receive MPEG streams, such as an MPEG2 transport multiplex that supports multiple programs in the same broadcast channel, with multiple video and audio feeds and private data. The output may be various conventional analog and/or digital signals as appropriate for the corresponding display device. For example, the output provided by the display interface may be an analog standard (e.g., NTSC), a digital standard (e.g., ATSC), or both, in embodiments functioning with a conventional analog or digital television. The output may also adhere to computer monitor standards, or any format for driving any type of display.

The device 100 includes both a working memory 112 as well as data storage 114. The memory 112 stores instructions that are executed by the CPU 110 to carry out the functionality described herein. The memory 112 also may buffer content as it is received and decoded, in conjunction with the content being provided as output to the display device. Additionally, larger amounts of content may be concurrently stored in the data storage 114 (e.g., hard disk), or programming may be regularly recorded onto the data storage 114 as part of a scheduled recording.

The device 100 also includes a content guide module 102 that manages the available content and displays menu lists from which content selections may be made. For example, the content guide module 102 may manage EPG data to provide the menu lists. The EPG data may include guide data, channel identification data, and program data. The guide data is general information, such as the current date and time. Additional information, such as channel list and segment information may also be included in the guide data. The channel identification data includes data relating to channels, such as the channel number, channel name (i.e., the call sign of a broadcast station), logo ID (i.e., an identification of the channel logo), data ID, which is an identification of a channel number of MPEG video data or MPEG audio data, and other information.

The program data includes the program title, start time of the program, time length of the program, program category such as movies, news, sports, etc., program subcategory such as drama, horror, children's for the movies category, or baseball, basketball, football for the sports category, the program rating and a program description that provides a detailed description of the program. The various program entries for each channel may be provided in the sequence with which they are to be shown, or in any desired fashion.

Embodiments are not limited to those in which only broadcast content is stored in the device 100. For example, a user may store personal videos, photos, music and other content items in the data storage 114, or, alternatively, the device 100 may retrieve such content items from an external storage device. The content guide module 102 is updated accordingly, to reflect all of the available content items.

The device 100 also includes a command interface 106 that allows for the receipt of commands from a remote commander 150. The communication channel between the remote commander 150 and the command interface 106 may be any conventional wireless communication, typically implementing an infrared signal but also potentially implementing RF or other technologies. The remote commander is configured to include various conventional numerical buttons and navigational (e.g., arrow) buttons that allow the user to send commands that prompt channel selection or navigation among available content. For example, a menu list such as the EPG may be displayed, and the user may cursor up or down within the displayed listing, and then press a “select” button or the like when the cursor resides on the desired content item, whereupon the content item is accessed, decoded if necessary, and output for display.

The remote commander 150 also includes a facility for receiving biometric information from a user. In one embodiment, the biometric information may be fingerprint information. There, a reception area is provided on the remote commander 150 through which the fingerprint information of a user is scanned. In conventional fashion, data corresponding to the fingerprint information is collected and compared to a database of known fingerprint data, which allows users to be identified accordingly. A registration mode wherein users' fingerprints are read and stored for future reference may also be provided. The collection of fingerprint data and the scanning of fingerprints in order to identify users is well known, and need not be described in detail herein for an understanding of this embodiment. It should also be understood that other forms of biometric identification may be provided, including voice recognition, facial recognition, retinal scanning, etc.

The menu selection module 104 accommodates the management and generation of menu lists in a fashion that tailors such lists according to the user, as identified through the biometric information. The menu selection module 104 is preferably provided as software that is executed by the CPU 110 in order to provide the functionality described herein. Alternatively, the menu selection module 104 may be provided as hardware or firmware, or any combination of software, hardware and/or firmware.

For example, in one embodiment, the menu selection module 104 is configured to automatically display differing menus from which selection of content is made, by obtaining biometric information of a user from a biometric device that is associated with a content access device through which access to content items is made, such as the remote commander 150. The user is then identified based upon the obtained biometric information, which may be performed by the menu selection module 104 by maintaining a database of registered users and matching the received biometric information to that database. Alternatively, the identification function may be performed by the remote commander 150, and passed to the menu selection module 104.

Once the identification is in place, the menu selection module 104 modifies a menu list from which a selection of content items to be accessed is made, which is specified based upon identification of the user. For example, a particular user may interface with the menu selection module 104 during a setup mode and select preferred channels that will be displayed in a program guide when that particular user is biometrically identified as described herein. Various levels of complexity may be provided, wherein the user may also indicates different preferences depending upon the time of day or other criteria. The menu selection module 104 extracts the preferred listings of content items (e.g., from the EPG). For example, where the user has indicated certain channels, the channel identification field in the EPG may be used to identify appropriate listings for the modified list for that particular user. Additional database functions may also be used to identify the various content items to be listed for the particular user.

The menu selection module 104 then prompts display of the modified menu list on the display device, so that it may be reviewed and accessed by the user for additional operations. When a selection of a content item is received from the displayed modified menu list, such as through additional remote commander 150 commands, access to the selected content item is provided using the device 100 in conventional fashion as described above (e.g., the music is played, the video is displayed, the photo is shown, etc.).

In some embodiments, the menu selection module 104 may implement more than one form of biometric identification for a particular user. This may allow the particular user to attribute different menu lists to different biometric attributes. For example, a thumb print on one hand may be used to trigger a main menu display for the particular user, and then another finger or a finger on the opposite hand may be used to trigger a further modified menu display (e.g., for sports only, or movies only, or still photos only, etc.).

As another example, the first biometric information that provides one menu list may be fingerprint information, and the second biometric information that provides another menu list for the same user may be voice recognition information. In this fashion, the user may provide initial authentication and identification through the fingerprint, but then may use more easily invoked voice commands to engage in further navigation of menu lists specific to that particular user. This may be useful where different types of content are accessed as well. For example, a family member “Dad” may apply his fingerprint for identification to enter his particular menu lists, and may then state “Photos” whereupon his particular photo album listings are shown, or may then state “Movies” whereupon listings of movies consistent with his previously entered preferences are shown.

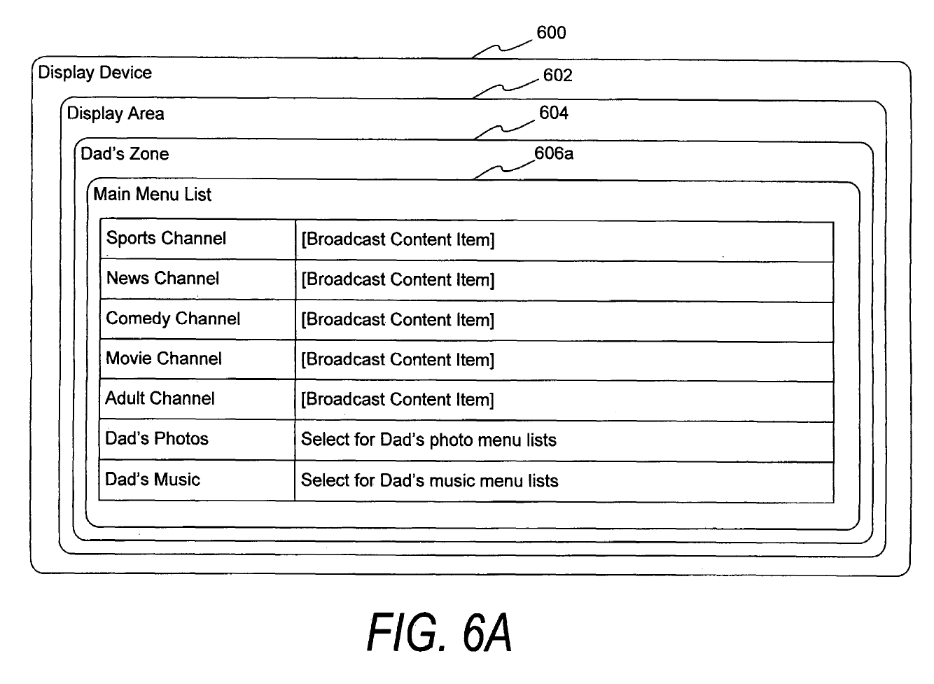

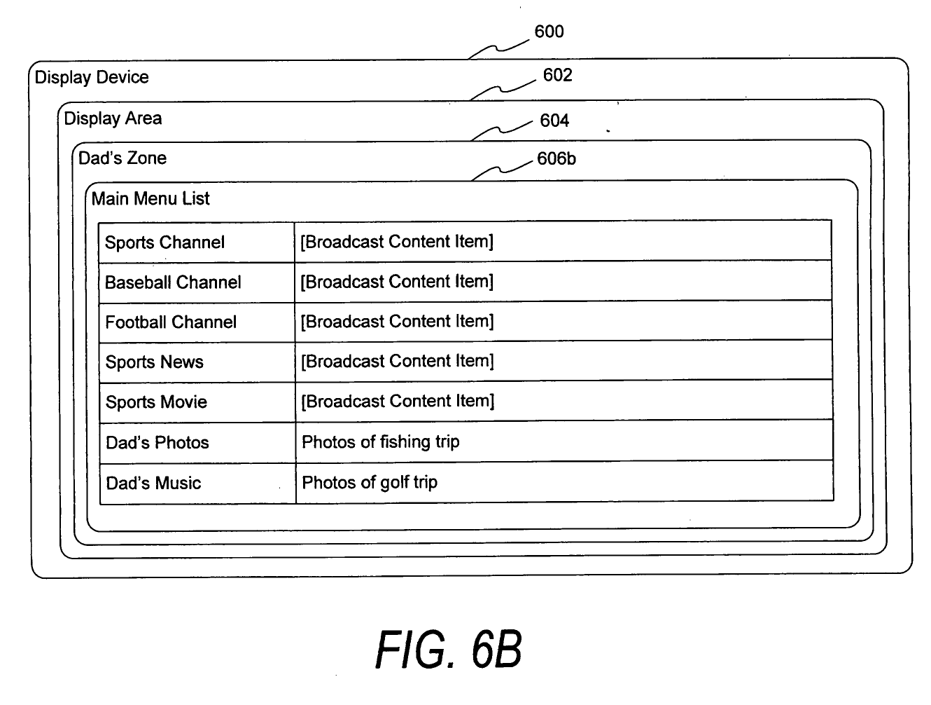

FIGS. 6A-B are display diagrams that respectively illustrate examples of a modified menu list 606a and a further modified menu list 606b corresponding to the described functionality. The menu lists 606a, 606b are displayed within the display area 602 of a display device 600 as driven by the content reproducing and recording device according to instructions provided by the menu selection module. As indicated in this example, a zone referred to as “Dad's Zone” 604 when “Dad” uses a thumbprint or the like to biometrically identify himself. In this instance, a modified menu list 606a particular to his content items is displayed. This may include both broadcast content and personal content (music, photos) as described. FIG. 6B illustrates a further modified menu list 606b, which may be prompted by voice recognition navigation. Here, upon stating a preference for the “sports” menu list, content item listings particular to that category are displayed for selection.

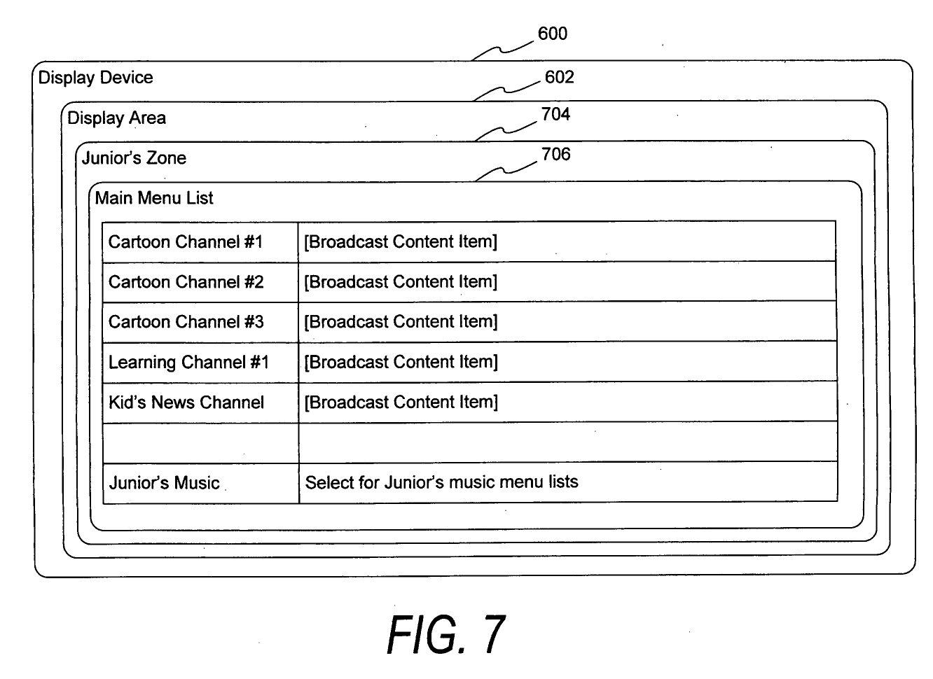

FIG. 7 is a display diagram illustrating another example of a modified menu list 706 with restricted content item access. Here, the zone may be that of a child, and may so indicate within the display area 704, in this example it is referred to as “Junior's Zone”. The menu list is similar to that previously described, and may also include both broadcast programming content and personal content items. However, here the parent or administrator may restrict access to the type of content that may be listed on the modified menu list 706. This prevents the child from selecting items available to other uses, including adult-oriented content and the like.

It is noted that in addition to a DVR type content recording and reproducing device, the described functionality may be carried out by various other types of devices, including a DVD player, a video game console, a personal computer, a home media center, or the like. It is also noted that a remote commander is not the only user selection device with biometric information sensing that may be implemented. Alternatives include but are not limited to a touch screen, a keyboard, a keyboard mouse combination, a microphone, a camera, etc.

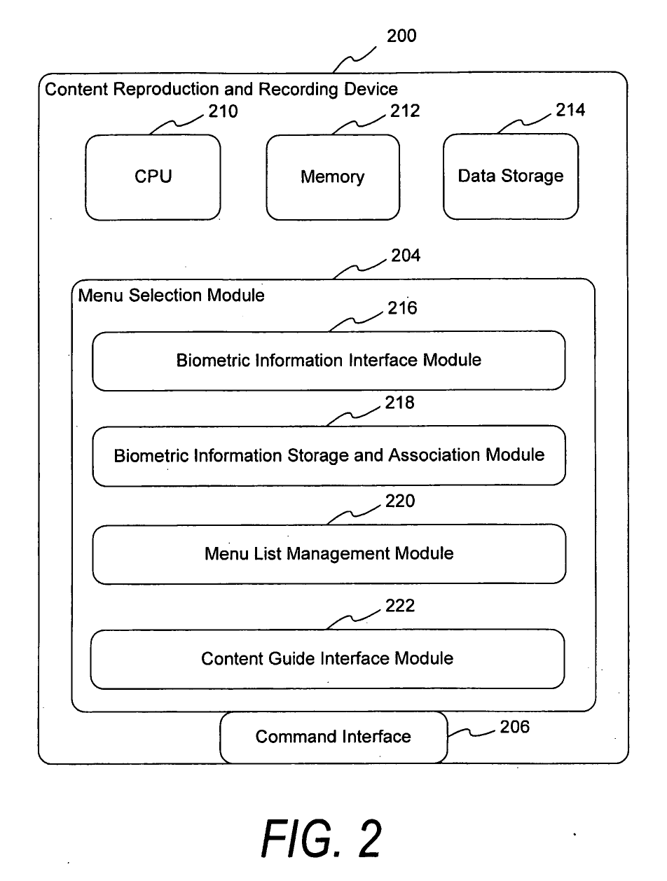

FIG. 2 is a block diagram further illustrating a content recording and reproducing device 200 configured to include menu selection based upon biometric identification. The device 200 similarly includes a CPU 210, memory 212, data storage 214, and command interface 206 performing the same functions as those described regarding the example of FIG. 1.

FIG. 2 illustrates an example of components of the menu selection module 200. The menu selection module 200, and components 216-222 are preferably provided as software that when executed by the CPU 210 provides the operations described herein. Alternatively the menu selection module 200 and its components 216-222 may be provided as hardware or firmware, or combinations of software, hardware and/or firmware. Additionally, although one example of the modularization of the menu selection module 200 is illustrated and described, it should be understood that the operations thereof may be provided by fewer, greater, or differently named modules.

The menu selection module 200 includes a biometric information interface module 216, a biometric information storage and association module 218, a menu list management module 220, and a content guide interface module 222.

The biometric information interface module 216 communicates with the external selection device (e.g., remote commander) through the command interface 206 to acquire biometric information of a user seeking access to the content accessed via the device 200.

The biometric information storage and association module 218 manages the biometric information of the various users accessing content via the device 200. This may entail registering various users and storing corresponding biometric information for each registered user in a database of biometric information.

For example, an administrator (e.g., head or household, primary user, administrator, etc.) may engage in a set up mode wherein they are registered as such through collection of appropriate biometric information (e.g., their fingerprint data as received through the remote commander as described above). Following this the administrator may permit additional subservient registrations (e.g., children, etc.), for whom biometric information may be received and registered in the same fashion. Subsequently, when these users seek to access content through the device 200, they initially must submit to biometric authentication and identification, and will then receive only menu lists corresponding to them. In addition to controlling the registration process, the administrator may also dictate the menu lists that are to be made available to the subservient users. This, for example, allows a head of household to limit the programming content, personal content, or any content to be accessed by children to be restrictively limited. (Alternatively, in a business environment, access to content may be limited based upon security levels corresponding to employees or the like—a network embodiment is described further below).

The menu list management module 220 maintains the listings corresponding to the various potential (e.g., registered) users. This may be organized in the form of a database that associates content items to each particular user, and may be further organized into additional preferences for each particular user, based upon fields identifying the appropriate content as well as other information. For example, the channel identifiers in a programming guide may be used to associate channels to particular users, and to generate specific menu lists of content items accordingly. The administrator may also designate particular content items as being accessible to various users, which may be carried out by associating a user identification number to the content item. Users may also customize their “zone” of content, by listing favorite channels, folders of photo items, etc. The database is updated accordingly to associate such content items with that user.

The global (for the device 200) organization of potentially available content items is organized in the content guide. This may include not only program guide data but also variously organized other content items as described. The content guide interface module 222 communicates with the menu list management module 220 and the content guide to carry out the display of menu lists particular to biometrically identified users. Once this is done, conventional selection of content items for reproduction by the device 200 is carried out as described above.

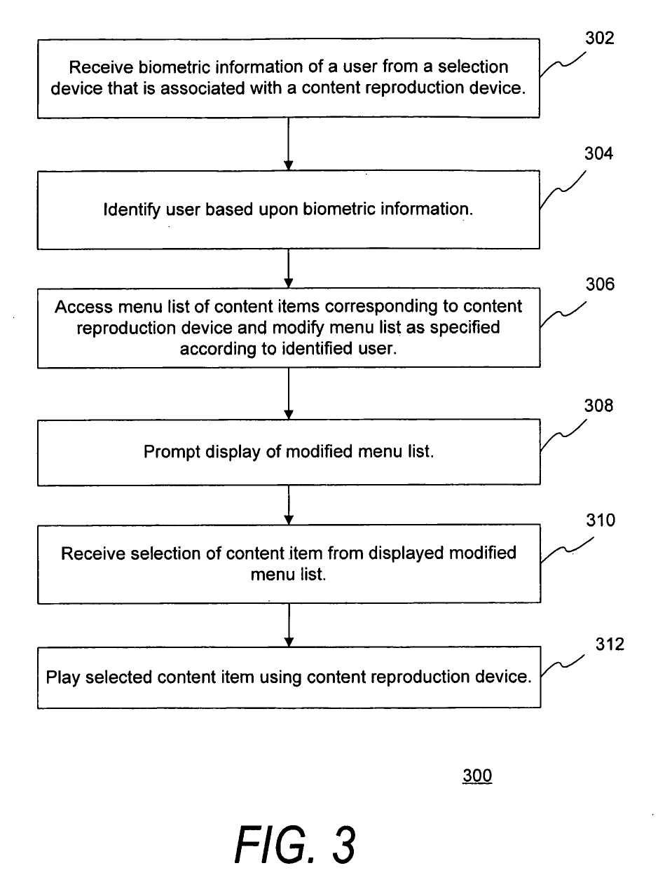

FIG. 3 is a flow diagram illustrating an example of a process 300 for automatically modifying menu lists of content items to be accessed through a content reproduction device, based upon biometric identification. The process commences with receipt 302 of biometric information of a user from a content selection device that is associated with the content reproduction device. As noted, this may be fingerprint information or other forms of biometric identification. Additionally, the information may be received from a remote commander through a relatively short range wireless connection, or may be provided through a network connection where a user is seeking to access content over the network.

The user is then identified 304 based upon the biometric information. As described, this may be accommodated through previous registration of the user along with collection of her biometric information, with storage and maintenance thereof.

Once the user is successfully identified, a menu list of available content items from the reproduction device is accessed 306, and is modified as specified for the identified user. The menu list of available content items may be a global listing of content items available via the reproduction device, and the list may be modified by associating particular content items to the particularly identified user in a database.

The modified menu list is then displayed 208 for review by the identified user, and then selection of a particular content item from the modified menu list is received 310, such as through remote commands as described, whereupon the selected content item is reproduced 312 by the content reproduction device. This may entail starting a recorded program, displaying one or more photos, playing selected music, etc.

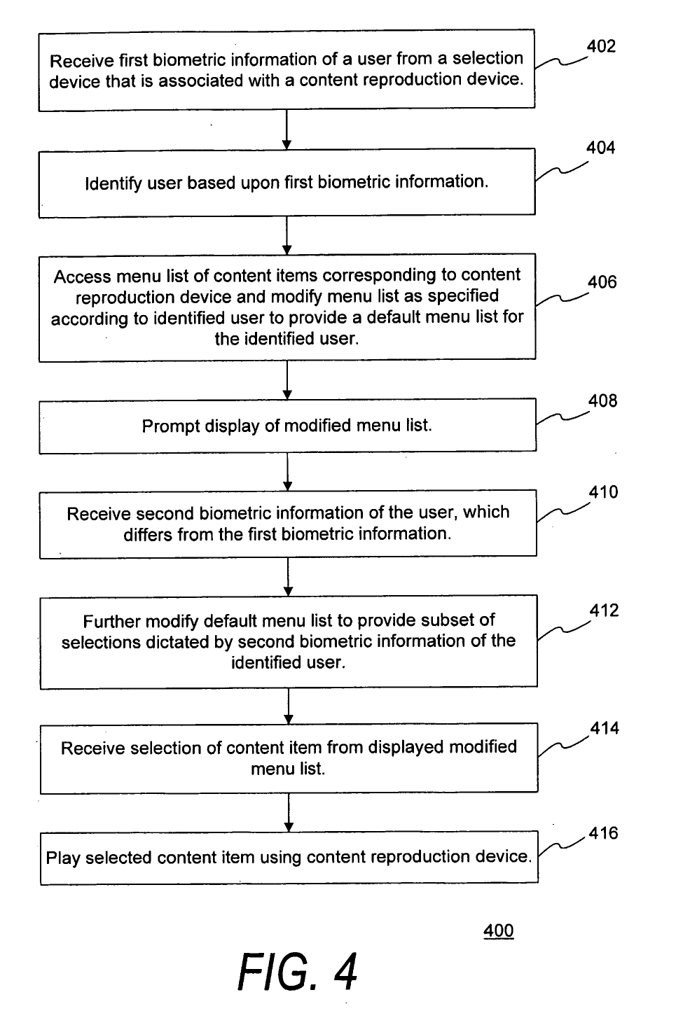

FIG. 4 is a flow diagram illustrating an example of a process 400 for further modifying menu lists of content items based upon first and second different biometric identifications.

Similarly, first biometric information of a user is received 402 via a content selection device associated with the content reproduction device. For example, the first biometric information may be fingerprint information. Then, as with the previously described process, the user is identified 404 based upon the first biometric information, an access 406 to the menu list of content items for the reproduction is made, with modification applied according to the identified user. This provides a default menu list or menu list zone corresponding to the identified user, based upon the first biometric information.

The modified menu list may be displayed accordingly (408). Once the user is identified via the first biometric information, additional biometric information that differs from the first biometric information may then be used to provide further modification of the menu listing of available content items (410). For example, this second biometric information may be voice recognition. The second biometric information may be similarly associated with particular users and maintained accordingly for subsequent matching.

Given the initial identification of the user according to the first biometric information as a prerequisite, further modification 412 of the menu listings of available content provide subset selections dictated by the second biometric information. For example, particular words or phrases made using the voice of the registered user (identified by the first biometric information such as a fingerprint previously) may be used to provide particular menu lists of content items. Thus, the user may initially identify herself using the fingerprint data, and then may make various voice commands to access particular favorite listings particular to her (which she may have previously customized by selecting favorite channels or other organizations of content items as described above).

From these modified listings, the content reproducing device may then receive 414 selection of content item(s) from the displayed modified listings, and reproduce 416 the selected content accordingly.

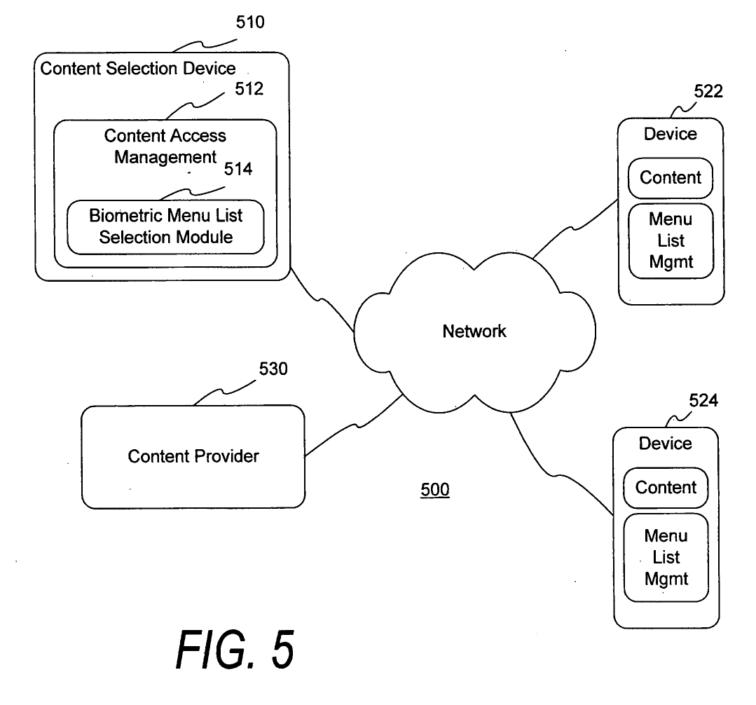

FIG. 5 is a schematic diagram illustrating an example of a network system 500 for navigating among content from various sources with biometric based menu list generation. The network system 500 may be a home network in whole or in part, wherein family members access to content is controlled by biometric authentication and identification, or may be a business network, wherein employee access to content is controlled by the same. Here, the content selection device 510 is configured to include a content access management module 512 that further includes a biometric menu list selection module 514. The biometric menu list selection module 514 offers the functionality of identifying users via biometric information, and displaying menu lists of available content items accordingly.

In this network embodiment, the content selection device 510 may preferably be embodied as a personal computer configured to include conventional processing capability, memory, a browsing application, network communication capabilities that allow the user to remotely navigate among content available in other devices 522, 524, or from a content provider 530 (e.g., the devices 522, 524 may be home devices, and the content provider 530 may be an external entity exercising control over a large library of content.).

Although a personal computer is noted, it should be understood that the content selection device 510 may be a portable handheld device as well, including but not limited to a media player, a cellular phone, a personal digital assistant, or the like.

In this system 500, the administrator may configure the content selection device 510 to only have access to certain content items over the network. For example, only certain items on device 522 may be available, only certain items on device 524 may be available, and access to content from the content provider 530 may be totally prevented. Each of these devices manages a menu list of available content items. The content selection device 510 is configured to solicit and receive biometric information from a user prior to allowing access to content. Once the user is identified, the biometric menu list selection module 514 shows only remotely accessible content items particular to the identified user, in the fashion described in detail above.

Thus embodiments of the present invention produce and provide biometric based menu privileges. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A computer-implemented method for automatically displaying differing menu listings from which selection of content is made, the method comprising:
obtaining biometric information of a user from a selection device that is associated with a content access device through which access to content items is made;
identifying the user based upon the obtained biometric information;
modifying a menu list from which a selection of content items to be accessed is made, the modification of the menu list being specified based upon identification of the user;
displaying the modified menu list and receiving a selection of a content item from the displayed modified menu list; and
providing access to the selected content item through the content access device.

2. The method according to claim 1, wherein the selected content item is video content.

3. The method according to claim 1, wherein the selected content item is audio content.

4. The method according to claim 1, wherein the biometric information is among a plurality of specified biometric information of the user, with a first specified biometric information causing display of a first modified menu list and a second specified biometric information causing display of a second modified menu list that differs from the first modified menu list.

5. The method according to claim 4, wherein the first and second specified biometric information are of different types.

6. The method according to claim 5, wherein the first specified biometric information is fingerprint information and the second specified biometric information is voice.

7. The method according to claim 4, wherein the first modified menu list contains content items of a first content type and the second modified menu list contains content items of a second content type that differs from the first content type.

8. The method according to claim 7, wherein the first content type is video content and the second content type is audio content.

9. A system for automatically displaying differing menu listings from which selection of content is made, the system comprising:
means for obtaining biometric information of a user from a selection device that is associated with a content access device through which access to content items is made;
means for identifying the user based upon the obtained biometric information;
means for modifying a menu list from which a selection of content items to be accessed is made, the modification of the menu list being specified based upon identification of the user;
means for prompting display of the modified menu list and receiving a selection of a content item from the displayed modified menu list; and
means for providing access to the selected content item through the content access device.

10. The system according to claim 9, wherein the selected content item is video content.

11. The system according to claim 9, wherein the selected content item is audio content.

12. The system according to claim 9, wherein the biometric information is among a plurality of specified biometric information of the user, with a first specified biometric information causing display of a first modified menu list and a second specified biometric information causing display of a second modified menu list that differs from the first modified menu list.

13. The system according to claim 12, wherein the first and second specified biometric information are of different types.

14. The system according to claim 13, wherein the first specified biometric information is fingerprint information and the second specified biometric information is voice.

15. The system according to claim 12, wherein the first modified menu list contains content items of a first content type and the second modified menu list contains content items of a second content type that differs from the first content type.

16. The system according to claim 15, wherein the first content type is video content and the second content type is audio content.

17. A computer program product for automatically displaying differing menu listings from which selection of content is made, the computer program product stored on computer readable medium and configured to provide operations comprising:
obtaining biometric information of a user from a selection device that is associated with a content access device through which access to content items is made;
identifying the user based upon the obtained biometric information;
modifying a menu list from which a selection of content items to be accessed is made, the modification of the menu list being specified based upon identification of the user;
displaying the modified menu list and receiving a selection of a content item from the displayed modified menu list; and
providing access to the selected content item through the content access device.

18. The computer program product according to claim 17, wherein the selected content item is video content.

19. The computer program product according to claim 17, wherein the selected content item is audio content.

20. The computer program product according to claim 17, wherein the biometric information is among a plurality of specified biometric information of the user, with a first specified biometric information causing display of a first modified menu list and a second specified biometric information causing display of a second modified menu list that differs from the first modified menu list.

21. The computer program product according to claim 20, wherein the first and second specified biometric information are of different types.

22. The computer program product according to claim 21, wherein the first specified biometric information is fingerprint information and the second specified biometric information is voice.

23. The computer program product according to claim 20, wherein the first modified menu list contains content items of a first content type and the second modified menu list contains content items of a second content type that differs from the first content type.

24. The computer program product according to claim 23, wherein the first content type is video content and the second content type is audio content.
